(19) United States
(12) Patent Application Publication
(10) Pub. No.: US 2016/0361226 A1
(43) Pub. Date: Dec. 15, 2016

(54) HARNESS FOR SEX

(71) Applicant: Edward Gibbs, Tampa, FL (US)

(72) Inventor: Edward Gibbs, Tampa, FL (US)

(21) Appl. No.: 14/735,636

(22) Filed: Jun. 10, 2015

(51) Int. Cl. A61H 19/00

(52) U.S. Cl. CPC A61H 19/50

(57) ABSTRACT

A sex harness with that can be removably worn by the user. The sex harness may have adjustable straps which can be tightened by a connection means. The sex harness allows for varied control by one partner can grab the straps of the other partner to increase penetration and have a different type of control.

### FIELD OF THE INVENTION

This invention relates to a harness that can be worn during sex to allow the participants to grab portions of the harness to pull towards the partner for either a deeper or more controlled penetration.

### BACKGROUND OF THE INVENTION

Currently, most sexual experiences among partners occur in the environment in which the sex partners have no clothes on, or some clothes, such as undergarments or lingerie. However these items do not provide the rigidity to grab and pull without damage to the clothing. And without any harness or clothing, the there a first partner has nothing to grab to bring the second partner closer for deeper penetration other then a limb, which has limitations as far as location and may cause injury.

There exists a need for a harness that can be used so that partners can have a more varied control and deeper penetration during sex. Deeper penetration during sexual intercourse may increase the chance of pregnancy for couples with fertility problems.

### SUMMARY OF THE INVENTION

One aspect of the present invention is a harness for sex (10), comprising: a leg portion (100) having a leg strap (90) that is removably disposed on a thigh of the user; a waist strap (70) that is removably disposed on the waist of the user; and a thigh strap (50) that is connected to said leg strap (90) and said waist strap (70).

Another aspect of the present invention is a harness for sex (10) comprising: an upper body portion (110) having a torso lower strap (120); a front vertical strap (30) disposed on said torso lower strap (120); a shoulder strap extending from said front vertical strap (30) to a neck strap (60); said shoulder strap extending from said neck strap to a rear vertical strap (150).

A third aspect of the present invention is a The harness for sex (10) comprising: a leg portion (100) having a leg strap (90) that is removably disposed on a thigh of the user; a waist strap (70) that is removably disposed on the waist of the user; a thigh strap (50) that is connected to said leg strap (90) and said waist strap (70); an upper body portion (110) having a torso lower strap (120); a front vertical strap (30) disposed on said torso lower strap (120); a shoulder strap extending from said front vertical strap (30) to a neck strap (60); and said shoulder strap extending from said neck strap to a rear vertical strap (150).

These and other features, aspects and advantages of the present invention will become better understood with reference to the following drawings, description and claims.

### BRIEF DESCRIPTION OF THE DRAWINGS

FIG. 1 is a pictorial view of one embodiment of the present invention;

FIG. 2 is another pictorial view of one embodiment of the present invention showing a leg portion;

FIG. 3 is another pictorial view of one embodiment of the present invention showing a side view of the leg portion;

FIG. 4 is an embodiment of the present invention as may be used during intercourse; and

FIG. 5 is an embodiment of the present invention showing a front view of the upper body portion and leg portion.

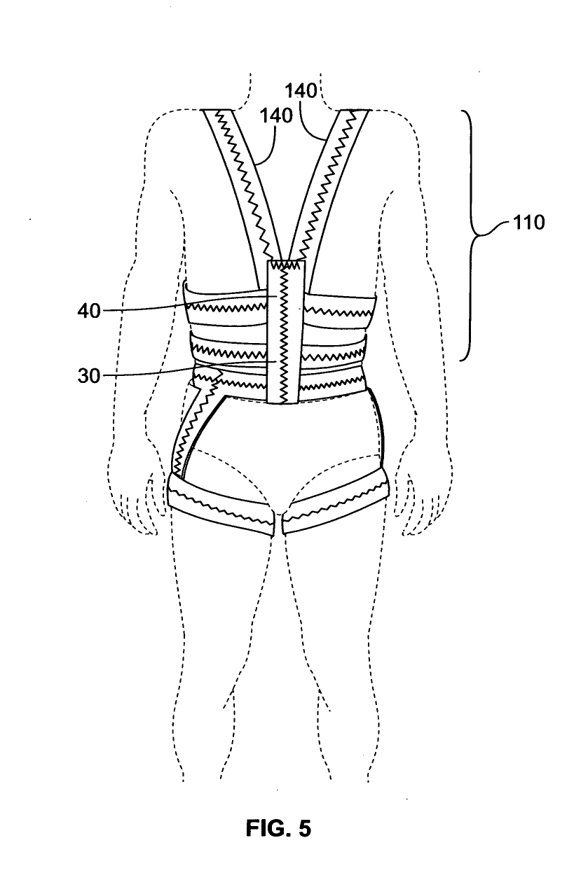

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Certain terminology will be used in the following description for convenience and reference only, and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words. Also, “connected to,” “secured to,” or similar language includes the definitions “indirectly connected to,” “directly connected to,” “indirectly secured to,” and “directly secured to.”

### REFERENCE NUMERALS LIST

10 present invention

20 torso strap

30 front vertical strap

40 horizontal strap

50 thigh strap

60 neck strap

70 waist strap

80 connection means

90 leg strap

100 leg portion

110 upper body portion

120 torso lower strap

130 torso upper strap

140 shoulder strap

150 rear vertical strap

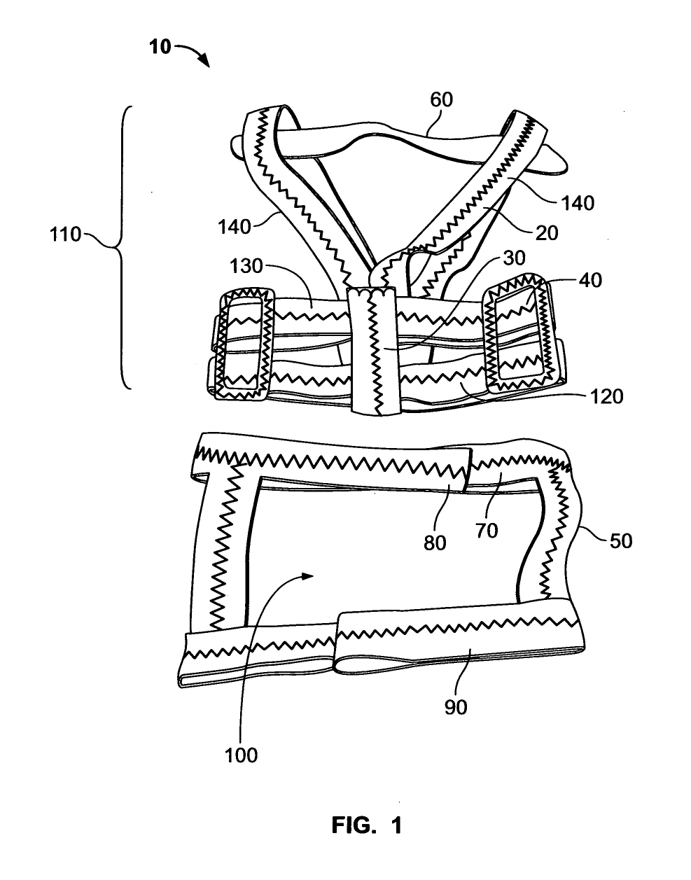

FIG. 1 illustrates an embodiment of the present invention 10, also called a sex harness 10 or harness for sex 10 or simply harness 10.

The harness 10 may have a waist strap 70 that can be wrapped around the waist of the user, and a connection means 80 to connect one portion of the waist strap 70 to another portion of the waist strap 70 so it can be removably connected to the waist of the user. In one embodiment the connection means 80 a belt buckle, and in another embodiment the connection means 70 is a loop and hook connection, such as velcro.

FIG. 1 also illustrates a vertical strap 50 that descends downwardly from the waist strap 70 to a leg strap 90.

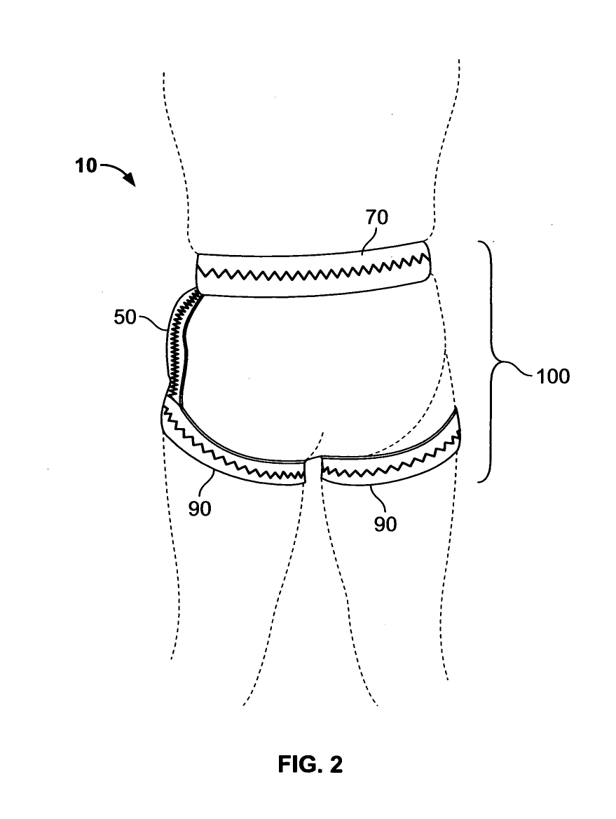

In one embodiment there are two (2) separate leg straps, one for each leg as seen in FIG. 2. Thus the invention 10 can be used with only the leg portion 100 without an upper body portion 110, or with only the upper body portion 110 without the leg portion 100, or the combination of the leg portion 100 with the upper body portion 110.

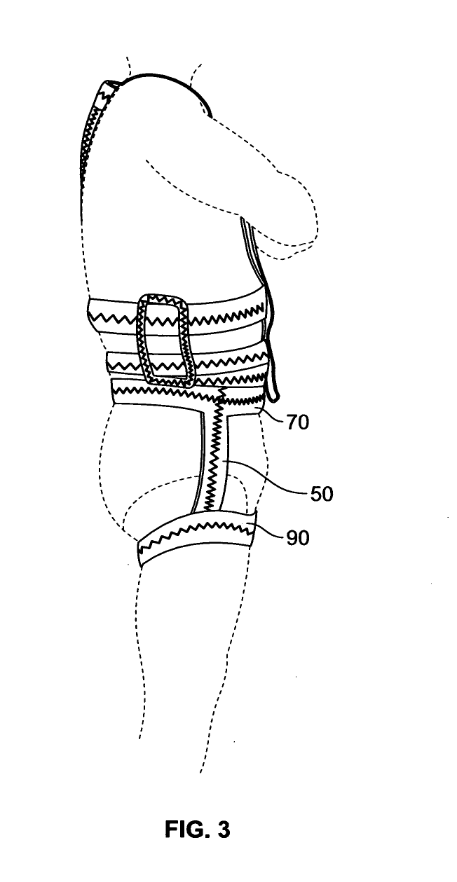

FIG. 1 also illustrates an embodiment of the upper body portion 110 having a torso lower strap 120 and a torso upper strap 130 connected together by a torso connection strap 20, which may be positioned on the left and right side of the user when in use, as seen in FIG. 3.

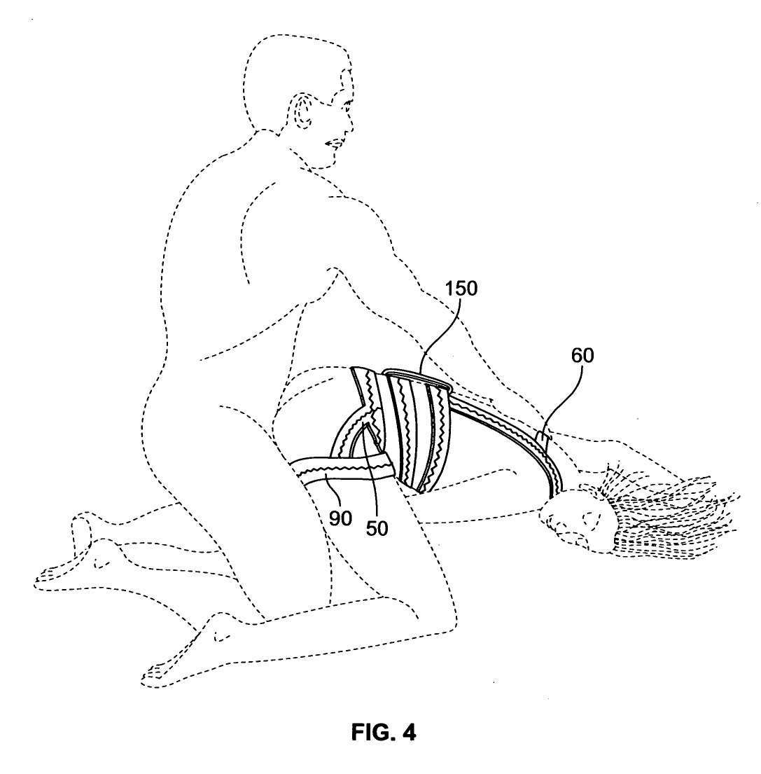

FIG. 1 also illustrates two shoulder straps 140 extending upwardly and from the rear side of the torso upper strap 130 to a neck strap 60 that can be positioned around the rear neck of the user, as seen in FIG. 4. The should straps 140 extend downwardly from the neck strap 60 in front of the user downwardly an inwardly to a vertical strap 30.

I claim:

1. A harness for sex (10), comprising:
a leg portion (100) having a leg strap (90) that is removably disposed on a thigh of the user;
a waist strap (70) that is removably disposed on the waist of the user; and
a thigh strap (50) that is connected to said leg strap (90) and said waist strap (70).

2. The harness for sex (10) comprising:
an upper body portion (110) having a torso lower strap (120);
a front vertical strap (30) disposed on said torso lower strap (120);
a shoulder strap extending from said front vertical strap (30) to a neck strap (60);
said shoulder strap extending from said neck strap to a rear vertical strap (150).

3. The harness for sex (10) comprising:
a leg portion (100) having a leg strap (90) that is removably disposed on a thigh of the user;
a waist strap (70) that is removably disposed on the waist of the user; and
a thigh strap (50) that is connected to said leg strap (90) and said waist strap (70).
an upper body portion (110) having a torso lower strap (120);
a front vertical strap (30) disposed on said torso lower strap (120);
a shoulder strap extending from said front vertical strap (30) to a neck strap (60); and
said shoulder strap extending from said neck strap to a rear vertical strap (150).
